(19) United States
(12) Patent Application Publication
(10) Pub. No.: US 2011/0026720 A1
(43) Pub. Date: Feb. 3, 2011

(54) SIGNAL PROCESSING APPARATUS AND SIGNAL PROCESSING METHOD

(75) Inventor: Yoshiki Ohta, Sakado (JP)

Correspondence Address: YOUNG & THOMPSON, 209 Madison Street, Suite 500, Alexandria, VA, 22314, US

(73) Assignee: PIONEER CORPORATION, Kawasaki-shi, Kanagawa-ken (JP)

(21) Appl. No.: 12/921,864

(22) PCT Filed: Jan. 26, 2009
(86) PCT No.: PCT/JP2009/051185

§ 371 Date: Sep. 10, 2010

(30) Foreign Application Priority Data
Mar. 10, 2008 (JP) PCT/JP2008/054290

(51) Int. Cl. H04R 5/00

(52) U.S. Cl. 381/17

(57) ABSTRACT

A surround effect in low-tone range can be improved when speakers to be positioned in front of a listener are used to realize a surround sound. A left surround signal extracting part 11 outputs a left surround signal Ls to a speaker LSP as it is, an attenuating part 12 attenuates the left surround signal Ls from the left surround signal extracting part 11, a delaying part 13 delays it per frequency band, and outputs it to a center speaker CSP, and a phase inverting part 14 inverts a phase of the left surround signal Ls from the left surround signal extracting part 11, and outputs it to a speaker RSP.

### TECHNICAL FIELD

The present invention relates to a technical field of a signal processing apparatus and signal processing method for processing a surround signal and outputting it to speakers to be positioned in front of a listener.

### BACKGROUND ART

Although surround speakers need to be positioned behind a listener in order to utilize a surround system such as 5.1 ch, a typical house does not have a space in which the surround speakers are to be positioned in many cases, and thus, there is proposed a front surround system which realizes a surround sound only by the front speaker.

A head-related transfer function is often used in such a front surround system (Patent Literature 1, for example), but there are problems that in the system using a head-related transfer function, a deterioration in sound quality occurs due to a large change in frequency characteristics of a sound source, and differences among individuals are caused in the effects of the system due to a shape of a listener's head.

The present inventors have thus proposed a surround reproduction system for outputting an input surround signal to one corresponding speaker out of the right and left speakers, while delaying and attenuating the surround signal by a predetermined amount of delay for each frequency band, and outputting it to the other speaker (Non-Patent Literature 1).

With the surround reproduction system, only a phase for each band is basically controlled so that a deterioration in sound quality is less, and information which depends on listener's characteristics such as a head-related transfer function is not used so that differences among individuals are less.

### Patent Literature 1: Japanese Patent Application Laid-Open No. 8-265899

Non-Patent Literature 1: The surround sound system consisting of two front loudspeakers by Kensaku OBATA, et al., Papers at the 12th Annual Conference of The Virtual Reality Society of Japan, September, 2007

### SUMMARY OF INVENTION

### Problems to be Solved by the Invention

However, in the surround reproduction system described in Non-Patent Literature 1, since the amount of diffraction is large in a band in which a wavelength of a sound output from the speaker is longer than the width of the head, for example, if a sound pressure of a left surround sound arriving at the right ear is tried to be lowered, there is the tendency that the left surround sound delayed (output from the right speaker) creeps to interfere with the left surround sound output from the left speaker, and consequently a sound pressure of the left surround sound also lowers at the left ear. Particularly, there is the tendency that the reduction in sound pressure is larger in low-tone range than in middle-tone and high-tone ranges.

Since a difference in sound pressure between both ears lowers due to the reduction in sound pressure, a localization angle of a sound image also lowers in a low-tone range.

Consequently, there is a disadvantage that a surround sound in a low-tone range comes from the front of the listener smaller than in middle-tone and high-tone ranges.

The present invention has been made in terms of the above problems, and one example of its objects is to provide a signal processing apparatus and a signal processing method capable of enhancing a surround effect in a low-tone range when a surround sound is realized by using speakers to be positioned in front of a listener.

### Means for Solving the Problems

In order to solve the above problems, one aspect of the invention relates to a signal processing apparatus comprising one outputting device which outputs an input surround signal to one speaker among the one right or left speaker for outputting one stereo sound to which the signal corresponds, the other speaker for outputting the other stereo sound, and a center speaker to be positioned between the one speaker and the other speaker,

the apparatus comprising:

an attenuating/delaying device which attenuates the input surround signal, and delays the surround signal per frequency band, and thereby generates an attenuated/delayed surround signal;

a center outputting device which outputs the generated attenuated/delayed surround signal to the center speaker;

a phase inverting device which inverts a phase of the input surround signal, and generates a reversed-phase surround signal; and

the other outputting device which outputs the generated reversed-phase surround signal to the other speaker.

Another aspect of the invention relates to a signal processing method including steps, the steps comprising:

outputting an input surround signal to one speaker among the one right or left speaker for outputting one stereo sound to which the signal corresponds, the other speaker for outputting the other stereo sound, and a center speaker to be positioned between the one speaker and the other speaker;

attenuating the input surround signal, delaying the surround signal per frequency band, thereby generating an attenuated/delayed surround signal, and outputting the attenuated/delayed surround signal to the center speaker; and

inverting a phase of the input surround signal, generating a reversed-phase surround signal, and outputting the reversed-phase surround signal to the other speaker.

### BRIEF DESCRIPTION OF DRAWINGS

FIG. 1 is a block diagram showing one example of a schematic configuration of a surround signal processing apparatus 10 according to a first embodiment;

FIG. 2 is a graph showing one example of the amount of optimum delay per frequency band;

FIG. 3 is a graph showing one example of a maximum localization angle per frequency;

FIG. 4 is a diagram showing one example of an average sound pressure level of a left surround sound arriving at both ears of a listener with contour lines in a comparative example;

FIG. 5 is a diagram showing one example of an average sound pressure level of a left surround sound arriving at both ears of the listener with contour lines in the surround signal processing apparatus 10 according to the first embodiment;

FIG. 6 is a graph showing one example of the amount of optimum delay and its approximate result per frequency band in the surround signal processing apparatus 10 according to the first embodiment;

FIG. 7 is a block diagram showing one example of a schematic configuration of an AV amplifier 50;

FIG. 8 is a block diagram showing one example of a schematic configuration of a surround signal processing apparatus 20 according to a second embodiment;

FIG. 9 is a block diagram showing one example of a schematic configuration of a surround signal processing apparatus 30 according to a third embodiment;

FIG. 10 is a diagram showing one example of a relationship between the amount of delay as well as a frequency and a localization angle in the comparative example;

FIG. 11 is a diagram showing one example of a relationship between the amount of delay as well as a frequency and a localization angle in the surround signal processing apparatus 10 according to the first embodiment;

FIG. 12 is a diagram showing one example of a relationship between the amount of delay as well as a frequency and a difference in sound pressure level between both ears in the comparative example; and

FIG. 13 is a diagram showing one example of a relationship between the amount of delay as well as a frequency and a difference in sound pressure level between both ears in the surround signal processing apparatus 10 according to the first embodiment.

### DESCRIPTION OF REFERENCE NUMERALS

10, 20, 30: Surround signal processing apparatus

11: Left surround signal extracting part

12, 24: Attenuating part

13, 25: Delaying part

14: Phase inverting part

21, 22, 31: Lowpass filtering part

23, 32: Highpass filtering part

26: Adding part

50: AV amplifier

51: Decoder

52, 55: Attenuator

53, 56: Allpass filter

54, 57: Phase inverting circuit

58, 59, 60: Adder

100: Listener

200: Sound image

LSP, RSP, LSSP, RSSP: Speaker

CSP: Center speaker

SW: Subwoofer

### BEST MODE FOR CARRYING OUT THE INVENTION

Hereinafter, preferred embodiments of the present invention will be described in detail with reference to the drawings.

### 1. First Embodiment

### [1.1 Configuration of Signal Processing Apparatus]

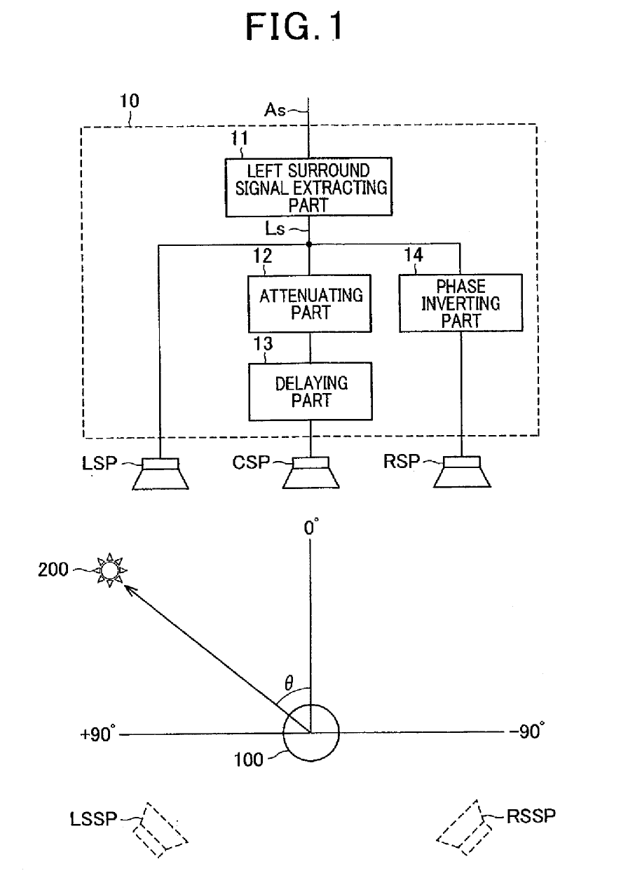

A configuration of a surround signal processing apparatus 10 according to a first embodiment will be first described with reference to FIG. 1.

FIG. 1 is a block diagram showing one example of a schematic configuration of the surround signal processing apparatus 10 according to the first embodiment.

The surround signal processing apparatus 10 according to the present embodiment is directed for processing a surround signal and thereby realizing a surround sound only by three front speakers such as a left front speaker, a right front speaker and a center speaker.

Only a configuration for processing a left surround signal will be described in the following description, but is also applicable to a configuration for processing a right surround signal.

As shown in FIG. 1, the surround signal processing apparatus 10 includes a left surround signal extracting part 11, an attenuating part 12, a delaying part 13 and a phase inverting part 14.

The left surround signal extracting part 11 constitutes one outputting means, the attenuating part 12 and the delaying part 13 constitute attenuating/delaying means, and the delaying part 13 constitutes center outputting means. Further, the phase inverting part 14 constitutes phase inverting means and the other outputting means.

The left surround signal extracting part 11 is input an audio stream signal As from the outside of the surround signal processing apparatus 10, and the left surround signal extracting part 11 extracts a left surround signal Ls from the audio stream signal As. The left surround signal extracting part 11 outputs the extracted left surround signal Ls to a speaker LSP (one example of one speaker) for outputting a left stereo sound, the attenuating part 12 and the phase inverting part 14, respectively.

The attenuating part 12 attenuates the left surround signal Ls supplied from the left surround signal extracting part 11 (6 dB, for example).

The delaying part 13 delays the left surround signal attenuated by the attenuating part 12 per frequency band. For example, the delaying part 13 divides the left surround signal ranging three octaves from about 250 Hz to about 2 KHz per one-third octave's band, delays it per divided band by a preset amount of delay, respectively, and combines the delayed signals of the frequency bands into one signal. Then the delaying part outputs the combined signal (one example of attenuated/delayed surround signal) to the center speaker CSP (one example of center speaker) for mainly outputting sound.

The amount of delay is set per frequency band such that a sound source felt by the listener 100, that is, a localization angle of the sound image 200 (angle in the front direction of the listener 100) is a maximum open angle.

There may be such a configuration that the left surround signal Ls is supplied from the left surround signal extracting part 11 to the delaying part 13 and the left surround signal Ls is delayed by the delaying part 13 and is then attenuated by the attenuating part 12.

The phase inverting part 14 inverts a phase of the left surround signal Ls supplied from the left surround signal extracting part 11 and outputs the inverted signal (one example of reversed-phase surround signal) to the speaker RSP for outputting a right stereo sound (one example of the other speaker).

### [1.2 Operations of Signal Processing Apparatus]

Operations of the surround signal processing apparatus 10 will be described below.

The audio stream signal As is input into the left surround signal extracting part 11 of the surround signal processing apparatus 10. Then, the left surround signal extracting part 11 extracts the left surround signal Ls from the audio stream signal As and outputs the signal to the speaker LSP, the attenuating part 12 and the phase inverting part.

The left surround signal Ls supplied to the attenuating part 12 is attenuated by the attenuating part 12 and then delayed by the delaying part 13 per frequency band, and subsequently is output to the center speaker CSP.

The left surround signal Ls supplied to the phase inverting part 14 is inverted by the phase inverting part 14 and is then output to the speaker RSP.

A sound corresponding to the left surround signal Ls itself output from the left surround signal extracting part 11 is output from the speaker LSP.

A sound corresponding to the left surround signal Ls delayed per frequency band after being attenuated is output from the center speaker CSP.

A sound corresponding to the left surround signal Ls with the inverted phase is output from the speaker RSP.

The listener 100 can listen to a surround sound as if a speaker LSSP for outputting a left surround sound and a speaker RSSP for outputting a right surround sound are placed at the positions shown in FIG. 1. The speaker LSSP and the speaker RSSP are merely virtually illustrated with dashed lines for convenient description.

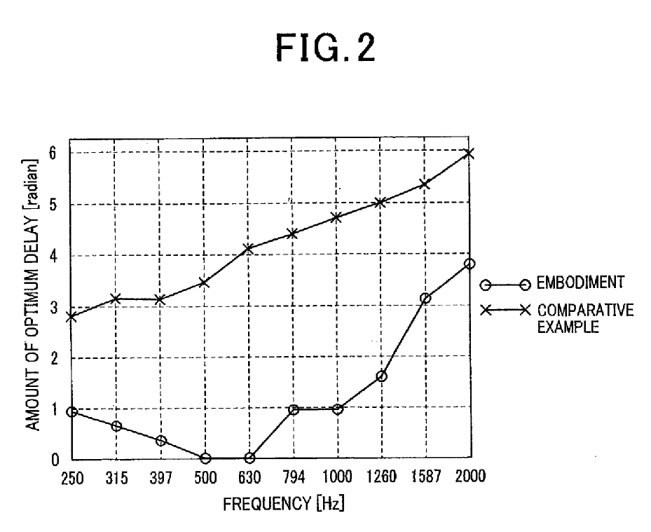

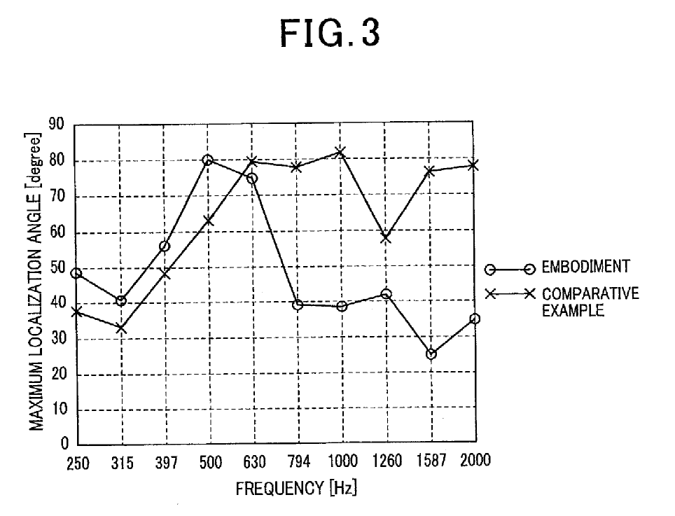

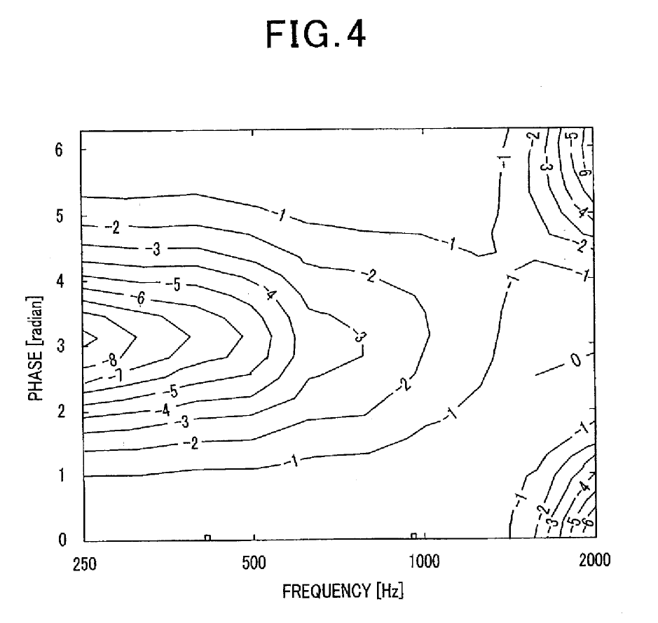

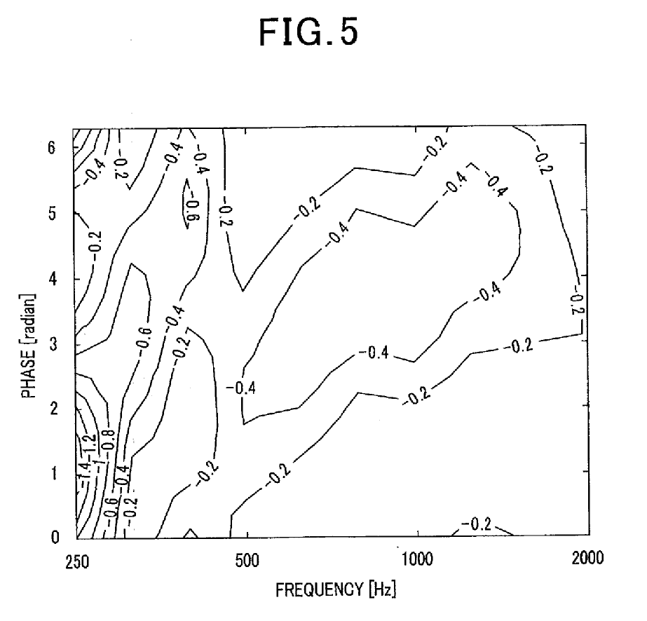

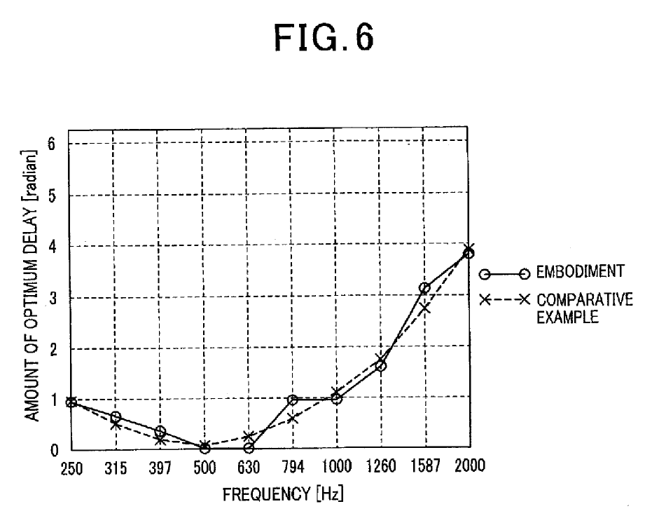

Subjective evaluations of the surround effect using the surround signal processing apparatus 10 will be described below with reference to FIG. 2 to FIG. 6. FIG. 2 is a graph showing one example of the amount of optimum delay per frequency band. FIG. 3 is a graph showing one example of a maximum localization angle per frequency. FIG. 4 is a diagram showing on example of an average sound pressure level of a left surround sound arriving at both eras of the listener 100 with contour lines in the comparative example. FIG. 5 is a diagram showing one example of an average sound pressure level of a left surround sound arriving at both ears of the listener 100 with contour lines in the surround signal processing apparatus 10 according to the first embodiment. FIG. 6 is a graph showing one example of the amount of optimum delay and its approximate result per frequency band in the surround signal processing apparatus 10 according to the first embodiment.

In the evaluations described later, an interval between the speaker LSP and the speaker RSP is assumed at 1.5 meters. The center speaker CSP is arranged at the center of the line connecting the speaker LSP and the speaker RSP. The listener 100 is positioned on the perpendicular bisector of the line connecting the speaker LSP and the speaker RSP, and a distance between the center speaker CSP and the listener 100 is assumed at 2 meters.

FIG. 2 is a graph showing the amount of optimum delay by which the localization angle of the sound image 200 is maximum in 10 frequency bands with the center frequency of 250 Hz, 315 Hz, 397 Hz, 500 Hz, 630 Hz, 794 Hz, 1000 Hz, 1260 Hz, 1587 Hz or 2000 Hz, respectively. As shown in FIG. 2, the amount of optimum delay is distributed in a range of about 0 to 4 radian, and particularly is less than one radian in the band having the center frequency of 500 Hz or less.

The comparative example will be also described. The comparative example has a similar configuration to the surround reproduction system described in Non-Patent Literature 1 described above. Specifically, the surround reproduction system is configured to output a left surround signal to the left front speaker as it is, on the other hand, to delay the left surround signal by an allpass filter by a preset amount of delay per frequency band and then to attenuate and output it to the right front speaker (only configuration for left surround signal).

Also in the comparative example, if the amount of optimum delay is set such that the localization angle of the sound image 200 is maximum, as shown in FIG. 2, the amount of delay is distributed in a range of about 3 to 6 radian and is larger than the amount of optimum delay of the surround signal processing apparatus 10 according to the present embodiment.

FIG. 3 is a graph showing a localization angle of the sound image 200 when the left surround signal is delayed per frequency band by the amount of optimum delay shown in FIG. 2.

As shown in FIG. 3, while the maximum localization angle is larger in the comparative example than in the present embodiment in the band having the center frequency of 630 Hz or more, the maximum localization angle is larger in the present embodiment than in the comparative example in the band having the center frequency of 500 Hz or less in which the surround effect is assumed to be weak in the comparative example. In other words, the surround effect in low-tone range is improved in the surround signal processing apparatus 100 according to the present embodiment.

FIG. 4 and FIG. 5 are the diagrams showing sound pressure characteristics between 250 Hz and 2 KHz when the amount of delay is set between 0 and 2π, where FIG. 4 is a diagram for the comparative example and FIG. 5 is a diagram for the surround signal processing apparatus 10 according to the present embodiment. Further, FIG. 4 and FIG. 5 are the diagrams in which the maximum sound pressure level is normalized to 0 dB and the sound pressure level is indicated with contour lines.

In the comparative example, when the graph shown in FIG. 2 is overlapped on FIG. 4, it can be seen that the sound pressure level lowers on the graph which the amount of optimum delay traces. Particularly, in the band having the center frequency of 500 Hz or less in which the amount of optimum delay is around π radian, the sound pressure level is at about −4 to −10 dB, that is, remarkably lowers.

On the other hand, in the present embodiment, for all the frequencies and the total amount of delay, the sound pressure level of about −1 dB or more is secured and is at least about −1.4 dB. Even with the overlapped graph shown in FIG. 2, the sound pressure level is preferably kept on the graph which the amount of optimum delay traces.

There will be described below a reason why the sound pressure level and the surround effect are improved in the band having the center frequency of 500 Hz or less.

The amount of diffraction increases in the band in which the wavelength of the surround sound is longer than the width of the head. In the comparative example, if a difference in sound pressure between both ears is tried to be caused for the surround sound having the wavelength, for example, the left surround sound output from the speaker RSP creeps around the head of the listener 100 and interferes with the left surround sound output from the speaker LSP. As shown in FIG. 2, since the amount of optimum delay in the comparative example is around a half wavelength at the center frequency of 500 Hz or less, the left surround sound output from the speaker LSP and the left surround sound output from the speaker RSP and crept around the head of the listener 100 substantially have a reversed-phase relationship along with the long wavelength.

This point may be regarded as one reason why the sound pressure level lowers when the surround sound reaches the ears of the listener 100.

The sound pressure level of the surround sound arriving at the ears of the listener 100 lowers at both ears, respectively, and consequently the difference in sound pressure between both ears increases very little. Thus, this is because the localization angle of the sound image does not increase and the surround effect lowers.

To the contrary, in the surround signal processing apparatus 10 according to the present embodiment, as shown in FIG. 2, the amount of optimum delay at the center frequency of 500 Hz or less is smaller than in the comparative example, and is near 0 radian.

Thus, the left surround sound output from the speaker LSP and the left surround sound output from the center speaker CSP substantially have an inphase relationship on the perpendicular bisector of the line connecting the speaker RSP and the center speaker CSP, which causes an increase in sound pressure level. Since the wavelength of the surround sound is relatively long, the sound pressure level increases also around the perpendicular bisector and consequently the sound pressure level of the left surround sound increases at the left ear of the listener 100.

On the other hand, the left surround sound output from the speaker RSP and the left surround sound output from the center speaker CSP substantially have a reversed-phase relationship on the perpendicular bisector of the line connecting the speaker RSP and the center speaker CSP, which causes a reduction in sound pressure level. Similar to the above, the sound pressure level lowers also around the perpendicular bisector and thus the sound pressure level of the left surround sound lowers at the right ear of the listener 100.

Therefore, since the sound pressure level increases at the left ear and the sound pressure level lowers at the right ear, the difference in sound pressure between both ears increases, the localization angle of the sound image increases, and consequently the surround effect is also improved.

The formula for finding the amount of optimum delay φ(f) at the frequency f of the surround signal is as follows:

$$\begin{matrix}[ Formula 1 ] & \\ φ ( f ) = {\sum }_{i = 0}^{2} P ( i ) \cdot {( {log}_{10} ( f ) )}^{i} & ( 1 )\end{matrix}$$

In the above formula (1), i indicates a dimension number and P(i) indicates a constant parameter. Here, when P(0)=74.7124, P(1)=−55.3851, and P(2)=10.2811 are assumed, the graph of the formula (1) is as shown in FIG. 6 and the amount of optimum delay obtained by the evaluation experiment shown in FIG. 2 can be approximated. Thus, an allpass filter having the phase delay characteristics can constitute the delaying part 13.

Since the maximum localization angle and the sound pressure level are different depending on a listening environment such as an interval between the speaker LSP and the speaker RSP and a distance between the speaker CSP and the listener 100, it is desirable that the amount of delay (or the constant parameter) per frequency band is decided based on the sufficient evaluation on the assumed listening environment.

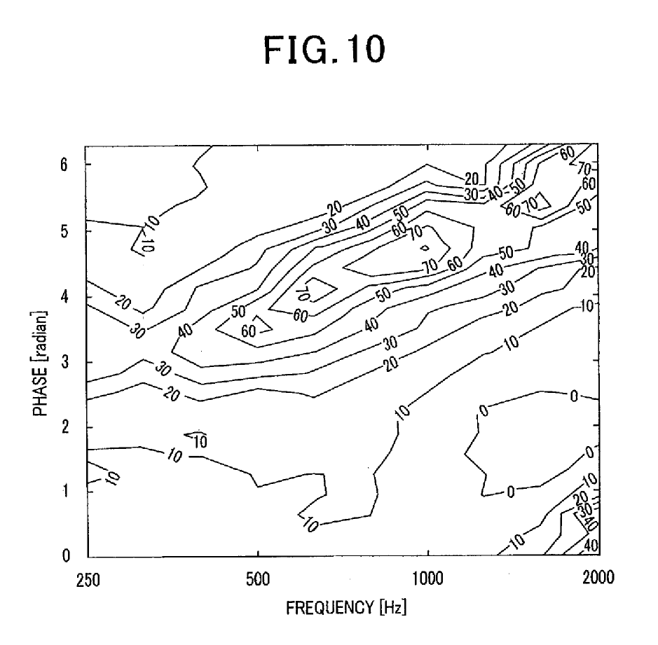

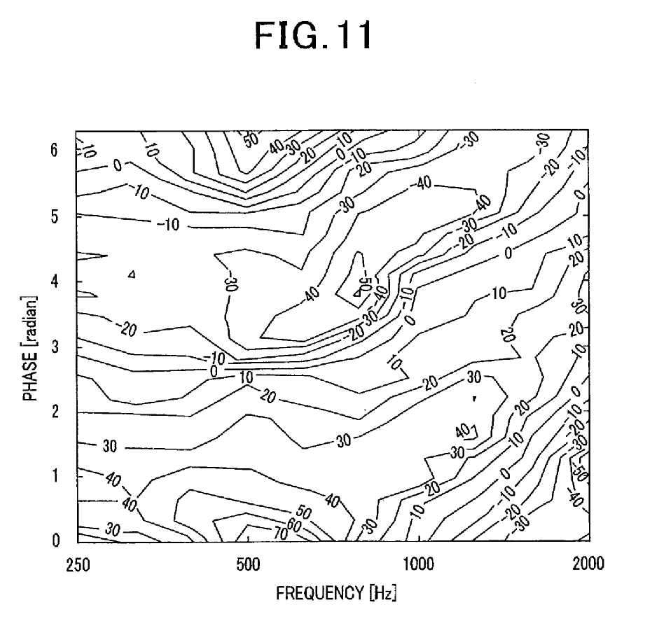

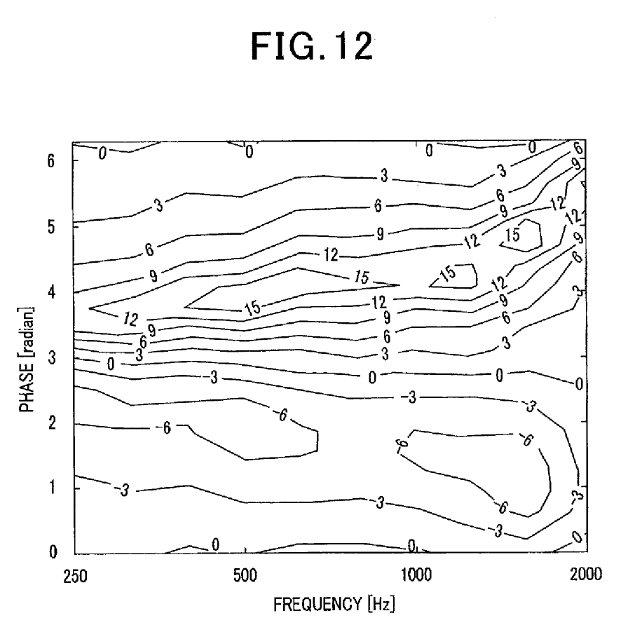

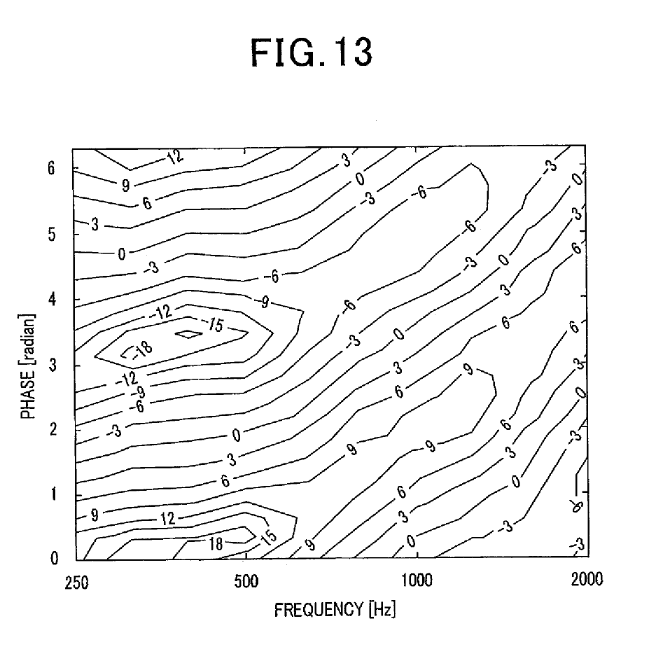

Other examples of how to find the amount of optimum delay per frequency band in the delaying part 13 (how to decide phase delay characteristics of the delaying part 13) will be described below with reference to FIG. 10 to FIG. 13. FIG. 10 is a diagram showing one example of a relationship between the amount of delay as well as a frequency and a localization angle in the comparative example. FIG. 11 is a diagram showing one example of a relationship between the amount of delay as well as a frequency and a localization angle in the surround signal processing apparatus 10 according to the first embodiment. FIG. 12 is a diagram showing one example of a relationship between the amount of delay as well as a frequency and a difference in sound pressure level between both ears in the comparative example. FIG. 13 is a diagram showing one example of a relationship between the amount of delay as well as a frequency and a difference in sound pressure level between both ears in the surround signal processing apparatus 10 according to the first embodiment.

The amount of optimum delay per frequency band has been found such that the localization angle of the sound image is maximum by the subjective evaluation in the above description, but maybe found by taking the difference in sound pressure level between both ears in objective experiments.

The results of the subjective evaluations will be described first. FIG. 10 and FIG. 11 are the diagrams showing the results of the subjective evaluations for deriving the maximum localization angle shown in FIG. 2, where FIG. 10 shows the result of the comparative example and FIG. 11 shows the result by the surround signal processing apparatus 10. In FIG. 10 and FIG. 11, the longitudinal axis indicates the amount of delay (phase), the horizontal axis indicates frequency, and the localization angle is indicated with contour lines.

The results are obtained based on the subjective evaluations per frequency of 250 to 2000 Hz and each amount of delay of 0 to 2π radian. Of course, the amount of delay (the amount of optimum delay), which is taken by the maximum localization angle per frequency, coincides with the graph shown in FIG. 2.

Next, the experimental environments are basically similar to those for the subjective evaluations. In other words, the interval between the speaker LSP and the speaker RSP is set at 1.5 meters and the center speaker CSP is arranged at the center of the line connecting the speaker LSP and the speaker RSP. Then, instead of the listener 100, a dummy head is positioned on the perpendicular bisector of the line connecting the speaker LSP and the speaker RSP and a distance between the center speaker CSP and the dummy head is set at 2 meters. A microphone is mounted on the right and left ears of the dummy head, respectively. Then, a recording device is connected to each microphone to measure a sound collecting level (sound pressure). The comparative example is similar except for the absence of the center speaker.

In the respective environments, the left surround signal is generated per frequency and each amount of delay, a test sound is output from the speakers, and the test sound is collected by the microphones mounted on both ears of the dummy head to find a difference in sound pressure level between both ears at this time (left ear's sound pressure level−right ear's sound pressure level).

FIG. 12 and FIG. 13 are the diagrams showing the results, where FIG. 12 shows the result for the comparative example and FIG. 13 shows the result for the surround signal processing apparatus 10. In FIG. 12 and FIG. 13, the longitudinal axis indicates the amount of delay (phase), the horizontal axis indicates frequency, and the difference in sound pressure level (dB) is indicated with contour lines.

When a comparison is made between FIG. 12 and FIG. 10 and between FIG. 13 and FIG. 11, respectively, for the results, it can be seen that a trend of the localization angle of the sound image is remarkably similar to a trend of the difference in sound pressure level between both ears. In other words, as the difference in sound pressure level between both ears is larger, the localization angle becomes larger, and as the difference in sound pressure level between both ears is smaller, the localization angle becomes smaller.

For example, in FIG. 12, the difference in sound pressure level is maximum around π radian between 250 Hz and 500 Hz, and the amount of delay at the maximum difference in sound pressure level gradually moves from π radian to 2π radian between about 500 Hz and about 2000 Hz. This substantially matches a combination (graph of the comparative example shown in FIG. 2) of the frequency and the amount of delay at which the maximum localization angle is positioned in FIG. 10.

In FIG. 13, the difference in sound pressure level is maximum around 0 to 0.5 radian between 250 Hz and 500 Hz, and the amount of delay at the maximum difference in sound pressure level gradually moves from 0 radian to 4 radian between about 500 Hz and 2000 Hz. This substantially matches with a combination (graph of the surround signal processing apparatus 10 shown in FIG. 2) of the frequency and the amount of delay at which the maximum localization angle is positioned in FIG. 11.

The above results indicate that the localization angle of the sound image is strongly influenced by the difference in sound pressure level between both ears. Thus, it may be considered that the localization angle of the sound image and the difference in sound pressure level between both ears have a correlation.

Therefore, based on the result shown in FIG. 13, the amount of delay at which the difference in sound pressure level between both ears is maximum may be set as the amount of optimum delay per frequency in the delaying part 12. Even if the amount of optimum delay is slightly offset from the amount of optimum delay shown in FIG. 2, the localization angle does not steeply fall around the maximum localization angle and the effects by the present embodiment can be sufficiently exerted as shown in FIG. 11.

Based on the fact that the localization angle of the sound image is strongly influenced by the difference in sound pressure level, it is apparent that if the arrangement of the speakers and the position of the listener (receiving/listening position) are within a typical range, these are previously decided and thus the amount of optimum delay can be found by the method described herein.

### [1.3 Example of Application to 5.1 ch Surround System]

There will be described below an application example when the present embodiment is applied to an AV amplifier of the 5.1 ch surround system.

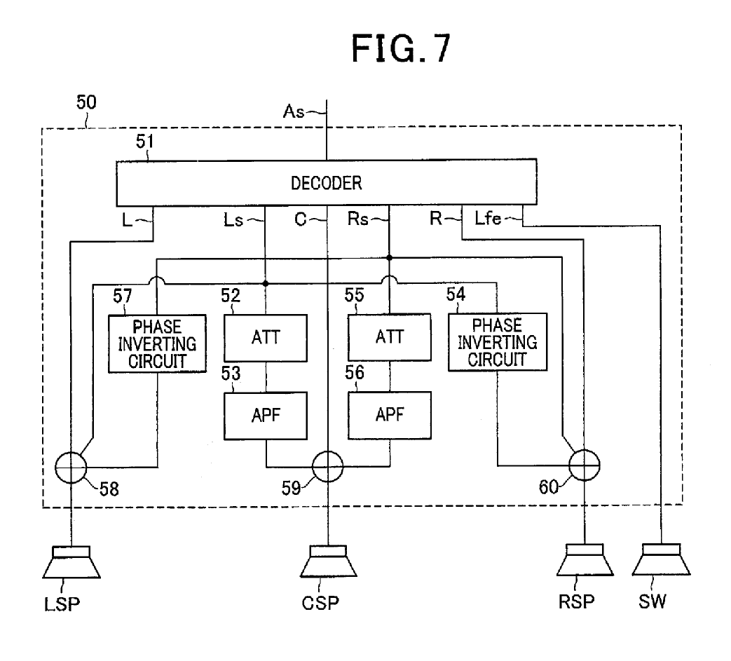

FIG. 7 is a block diagram showing one example of a schematic configuration of an AV amplifier 50.

As shown in FIG. 7, the AV amplifier 50 includes a decoder 51, attenuators 52 and 55, allpass filters 53 and 56, phase inverting circuits 54 and 57, and adders 58, 59 and 60.

The attenuator 52 and the allpass filter 53 constitute attenuating/delaying means corresponding to the left surround signal, and the phase inverting circuit 54 constitutes phase inverting means corresponding to the left surround signal. The attenuator 55 and the allpass filter 56 constitute attenuating/delaying means corresponding to the right surround signal, and the phase inverting circuit 57 constitutes phase inverting means corresponding to the right surround signal. The adder 58 constitutes one outputting means corresponding to the left surround signal and the other outputting means corresponding to the right surround signal. The adder 59 constitutes center outputting means. The adder 60 constitutes one outputting means corresponding to the right surround signal and the other outputting means corresponding to the left surround signal.

To the decoder 51 is supplied the audio stream signal As from the outside of the AV amplifier 50, and the decoder 51 further decodes the audio stream signal As and outputs the left stereo signal L, the right stereo signal R, the center signal C, the left surround signal Ls, the right surround signal Rs and the low-tone range effect signal Lfe.

The left stereo signal L output from the decoder 51 is supplied to the adder 58. The right stereo signal R is supplied to the adder 60. The center signal C is supplied to the adder 59.

The left surround signal Ls is supplied to the attenuator 52, the phase inverting circuit 54 and the adder 58, respectively. The right surround signal Rs is supplied to the attenuator 55, the phase inverting circuit 57 and the adder 60, respectively. The low-tone range effective signal Lfe is supplied to the subwoofer SW.

The attenuator 52 attenuates the left surround signal Ls. The allpass filter 53 delays the left surround signal attenuated by the attenuator 52 per frequency band and outputs the delayed signal (one example of attenuated/delayed surround signal) to the adder 59. The phase inverting circuit 54 inverts the phase of the left surround signal Ls and outputs the inverted signal (one example of reversed-phase surround signal) to the adder 60.

The attenuator 55 attenuates the right surround signal Rs. The allpass filter 56 delays the left surround signal attenuated by the attenuator 55 per frequency band and outputs the delayed signal (one example of attenuated/delayed surround signal) to the adder 59. The phase inverting circuit 57 inverts the phase of the right surround signal Rs and outputs the inverted signal (one example of reversed-phase surround signal) to the adder 58.

The configuration and function of the allpass filters 53 and 56 are the same as the delaying part 13 and their phase delay characteristics are indicated by the above formula (1) and the constant parameter.

The adder 58 adds the left stereo signal Ls from the decoder 51, the left surround signal Ls from the decoder 51 and the output signal from the phase inverting circuit 57 and outputs the added signals (examples of one addition signal and the other addition signal) to the speaker LSP.

The adder 59 adds the center signal C from the decoder 51, the output signal from the allpass filter 53, and the output signal from the allpass filter 56 and outputs the added signal (one example of center addition signal) to the speaker CSP.

The adder 60 adds the right stereo signal Rs from the decoder 51, the right surround signal Rs from the decoder 51 and the output signal from the phase inverting circuit 54 and outputs the added signals (examples of one addition signal and the other addition signal) to the speaker RSP.

With the surround system comprising the above-configured AV amplifier 50, the listener can enjoy the 5.1 ch surround sound.

The present embodiment is not limited to 5.1 ch and applicable to a surround system such as 5 ch or 6.1 ch.

As described above, according to the present embodiment, the left surround signal extracting part 11 outputs the left surround signal Ls to the speaker LSP as it is, the attenuating part 12 attenuates the left surround signal Ls from the left surround signal extracting part 11, the delaying part 13 delays it per frequency band and outputs it to the center speaker CSP, and the phase inverting part 14 inverts the phase of the left surround signal Ls from the left surround signal extracting part 11 and outputs it to the speaker RSP, thereby improving the surround effect in low-tone range. Similar effects can be obtained by similar operations also for the right surround signal.

### [2. Second Embodiment]

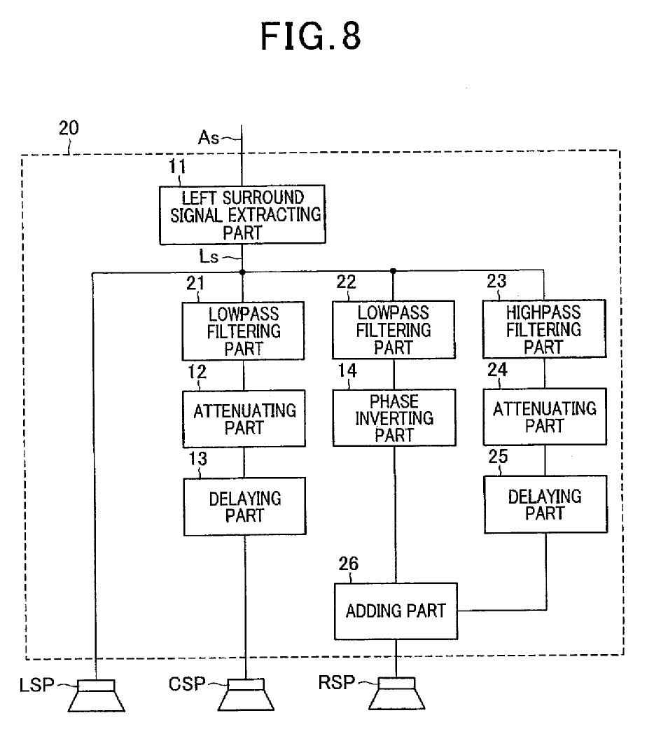

A second embodiment will be described below with reference to FIG. 8.

FIG. 8 is a block diagram showing one example of a schematic configuration of a surround signal processing apparatus 20 according to the second embodiment, where like reference numerals are denoted to like elements similar to those in FIG. 1.

Although the surround effect in middle- and high-tone ranges is lower in the aforementioned first embodiment than in the comparative example as shown in FIG. 3, there will be described a case in which the configuration of the surround signal processing apparatus 10 is combined with the configuration of the comparative example for enhancing the surround effect in middle- and high-tone ranges in the present embodiment.

As shown in FIG. 8, the surround signal processing apparatus 20 includes the left surround signal extracting part 11, the attenuating part 12, the delaying part 13, the phase inverting part 14, the lowpass filtering parts 21 and 22, the highpass filtering part 23, an attenuating part 24, a delaying part 25 and an adding part 26.

The left surround signal extracting part 11 constitutes one outputting means, the attenuating part 12 and the delaying part 13 constitute attenuating/delaying means, the delaying parts 13 constitutes center outputting means, and the phase inverting part 14 constitutes phase inverting means. The lowpass filtering parts 21 and 22 constitute first filtering means, the highpass filtering part 23 constitutes second filtering means, the attenuating part 24 and the delaying part 25 constitute second attenuating/delaying means, and the adding part 26 constitutes the other outputting means.

The left surround signal extracting part 11 outputs the left surround signal Ls extracted from the audio stream signal As to the speaker LSP, the lowpass filtering part 21, the lowpass filtering part 22 and the highpass filtering part 23, respectively.

The lowpass filtering parts 21 and 22 cut a signal component having a higher frequency than a predetermined frequency (detailed later) of the left surround signal Ls supplied from the left surround signal extracting part 11, and output a signal component having the predetermined frequency or less. Then, the output signal from the lowpass filtering part 21 is supplied to the attenuating part 12 and the output signal from the lowpass filtering part 22 is supplied to the phase inverting part 14.

The signal supplied to the attenuating part 12 is attenuated by the attenuating part 12 and then delayed per frequency band by the delaying part 13 to be output to the speaker CSP. The delaying part 12 divides the signal from about 250 Hz to about 500 Hz per one-third octave's band and delays it per divided band by a preset amount of delay.

The signal supplied to the phase inverting part 14 is inverted in its phase by the phase inverting part 14 and is output to the adding part 26.

The highpass filtering part 23 cuts a signal component having a predetermined frequency or less of the left surround signal Ls supplied from the left surround signal extracting part 11 and outputs a signal component having a higher frequency than the predetermined frequency to the attenuating part 24.

The attenuating part 24 attenuates the output signal from the highpass filtering part 23 (3 dB, for example).

The delaying part 25 delays the output signal attenuated by the attenuating part 24 per frequency band. For example, the delaying part 25 divides the signal from about 630 Hz to about 2 KHz per one-third octave's band, delays it per divided band by a preset amount of delay, and combines the delayed signals for the respective frequency bands into one signal. Then, the delaying part 25 outputs the combined signal (one example of second attenuated/delayed surround signal) to the adding part 26.

The amount of delay in the delaying part 25 is set per frequency band such that the localization angle of the sound image 200 is maximum (refer to the maximum localization angle in the comparative example shown in FIG. 3). At this time, for example, the delaying part 25 may be constituted by an allpass filter having phase delay characteristics obtained by approximating the amount of optimum delay in the comparative example shown in FIG. 2 by the approximate formula.

The amount of delay in the delaying part 25 may be set per frequency band such that the difference in sound pressure level between both ears is maximum as described above (see FIG. 12).

The adding part 26 adds the output signal from the phase inverting part 14 and the output signal from the delaying part 25 and outputs the added signals to the speaker RSP.

In this manner, the surround signal processing apparatus 20 is configured to invert the phase of the left surround signal Ls by the phase inverting part 14 similar to that in the surround signal processing apparatus 10 in low-tone range (frequency band having a predetermined frequency or less) when outputting it to the speaker RSP, on the other hand, to attenuate and delay it by the attenuating part 24 and the delaying part 25 similar to those in the comparative example in middle- and high-tone ranges (frequency band having a predetermined frequency or higher) and to add both the output signals by the adding part 26.

On the other hand, the configuration of the left speaker LSP is the same in the surround signal processing apparatus 10 and in the comparative example and the configuration of the center speaker CSP is present only in the surround signal processing apparatus 10, and thus the configuration of the surround signal processing apparatus 20 therefor is the same as the surround signal processing apparatus 10.

The aforementioned predetermined frequency, that is, the cutoff frequency in the lowpass filtering parts 21 and 22 as well as the highpass filtering part 23 is assumed as boundary frequency for dividing a band having the center frequency of 500 Hz and a band having the center frequency of 630 Hz. In other words, as shown in FIG. 3, the surround effect in the first embodiment is higher than in the comparative example in the band having the center frequency of 500 Hz or less and the surround effect in the comparative example is higher than in the first embodiment in the band having the center frequency of 630 Hz or more, and consequently the boundary frequency is assumed as the cutoff frequency.

The cutoff frequency is decided in this way so that the maximum localization angle of the sound image 200 is the same as in the first embodiment in the band having the center frequency of 500 Hz or less and is the same as in the comparative example in the band having the center frequency of 630 Hz or more, and thus the surround effect is improved in the band having the center frequency of 630 Hz or more.

Since the maximum localization angle and the sound pressure level are different depending on the listening environment such as the interval between the speaker LSP and the speaker RSP and the distance between the center speaker CSP and the listener 100, it is desirable that the cutoff frequency is decided by making sufficient evaluations on the assumed listening environment.

Further, the method of deciding a cutoff frequency may decide a cutoff frequency only based on the maximum localization angle, and further may decide it based on sound pressure characteristics (see FIG. 4 and FIG. 5) or may decide it based on both the maximum localization angle and the sound pressure characteristics. With the decision based on the sound pressure characteristics, a frequency at which the sound pressure level steeply lowers may be assumed as the cutoff frequency.

Still further, the method for deciding a cutoff frequency may decide a cutoff frequency based on a difference in sound pressure level between both ears. For example, when the amount of optimum delay is found from the difference in maximum sound pressure level shown in FIG. 12 and FIG. 13, the difference in maximum sound pressure level in the first embodiment is larger than the difference in maximum sound pressure level in the comparative example at about 500 Hz or less and the difference in maximum sound pressure level in the comparative example is larger than the difference in maximum sound pressure level in the first embodiment at about 600 Hz or more, and thus the cutoff frequency is decided between 500 Hz and 600 Hz.

As described above, according to the present embodiment, in addition to the effects by the operations of the first embodiment, the lowpass filtering parts 21 and 22 output a signal component having a predetermined frequency or less of the left surround signal Ls to the attenuating part 12 and the phase inverting part 14, the attenuating part 12 attenuates the output signal from the lowpass filtering part 21, the delaying part 13 delays it per frequency band and outputs it to the center speaker CSP, the phase inverting part 14 inverts a phase of the output signal from the lowpass filtering part 22 and outputs it to the adding part 26, the highpass filtering part 23 outputs a signal component having a higher frequency than the predetermined frequency of the left surround signal Ls to the attenuating part 24, the attenuating part 24 attenuates the output signal, the delaying part 25 delays it per frequency band, and the adding part 26 adds the output signal from the phase inverting part 14 and the output signal from the delaying part 25 to be output to the speaker RSP, thereby improving the surround effect in low-tone range and further improving the surround effect in middle- and high-tone ranges.

### [3. Third Embodiment]

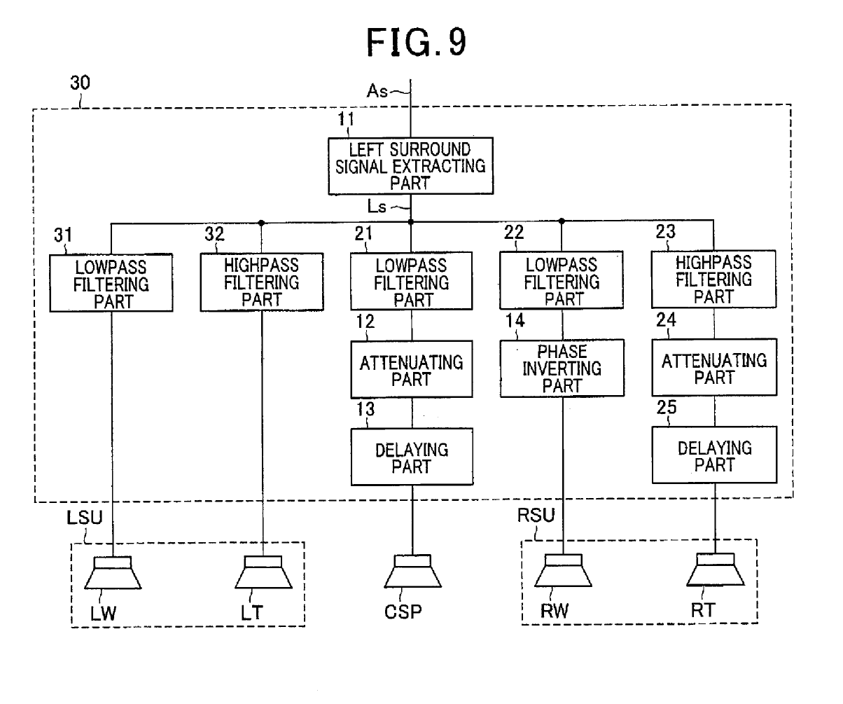

A third embodiment will be described below with reference to FIG. 9.

FIG. 9 is a block diagram showing one example of a schematic configuration of a surround signal processing apparatus 30 according to the third embodiment, where like reference numerals are denoted to like elements similar to those in FIG. 2.

Although a surround signal is output to the right and left speakers in the aforementioned second embodiment, there will be described a case in which a surround signal is output to a 2-way speaker in the present embodiment.

As shown in FIG. 9, the surround signal processing apparatus 30 includes the left surround signal extracting part 11, the attenuating parts 12 and 24, the delaying parts 13 and 25, the phase inverting part 14, the lowpass filtering parts 21, 22 and 31, and the highpass filtering parts 23 and 32.

The lowpass filtering part 31 and the highpass filtering part 32 constitute one outputting means, the attenuating part 12 and the delaying part 13 constitute attenuating/delaying means, the delaying part 13 constitutes center outputting means, and the phase inverting part 14 constitutes phase inverting means. Further, the lowpass filtering parts 21 and 22 constitute first filtering means, the highpass filtering part 23 constitutes second filtering means, the attenuating part 24 and the delaying part 25 constitute second attenuating/delaying means, and the phase inverting part and the delaying part 35 constitute the other outputting means.

In the present embodiment, instead of the speakers LSP and RSP, a speaker unit LSU (one example of one speaker) constituted with a woofer LW and a tweeter LT and a speaker unit RSU (one example of the other speaker) constituted with a woofer RW (one example of low-tone range speaker) and a tweeter RT (one example of high-tone range speaker) are arranged.

The left surround signal extracting part 11 outputs the left surround signal Ls extracted from the audio stream signal As to the lowpass filtering part 21, the lowpass filtering part 22, the highpass filtering part 23, the lowpass filtering part 31 and the highpass filtering part 32, respectively.

The lowpass filtering part 31 cuts a signal component having a higher frequency than a predetermined frequency of the left surround signal Ls supplied from the left surround signal extracting part 11 and outputs a signal component having the predetermined frequency or less to the woofer LW of the speaker unit LSU.

The highpass filtering part 32 cuts a signal component having a predetermined frequency or less of the left surround signal Ls supplied from the left surround signal extracting part 11 and outputs a signal component having a higher frequency than the predetermined frequency to the tweeter LT of the speaker unit LSU.

The configuration of the lowpass filtering part 31 is the same as that of the lowpass filtering parts 21 and 22 and its cutoff frequency is also the same as that thereof. The configuration of the highpass filtering part 32 is the same as that of the highpass filtering part 23 and its cutoff frequency is also the same as that thereof.

The output signal from the phase inverting part 14 is supplied to the woofer RW of the speaker unit RSU. The output signal from the delaying part 35 is supplied to the tweeter RT of the speaker unit RSU.

In this way, in the present embodiment, the low-tone range component of the surround signal is output to the woofer and the middle- and high-tone range component of the surround signal is output to the tweeter.

As described above, since the output signal from the phase inverting part 14 is supplied to the woofer RW and the output signal from the delaying part 35 is supplied to the tweeter RT in the present embodiment, the effects similar to those in the second embodiment can be obtained, and the respective output signals are supplied to the speakers confirming to the frequency band, respectively, thereby improving the sound quality.

Of course, the second embodiment or third embodiment is applicable to a surround system such as 5.1 ch like the first embodiment.

The present invention is not limited to the above embodiments. The above embodiments are exemplary, and any configurations having substantially the same configuration as the technical spirit described in the following claims of the present invention and having similar operational effects are encompassed within the technical scope of the present invention.

1-6. (canceled)

7. A signal processing apparatus comprising one outputting device which outputs an input surround signal to one speaker among the one right or left speaker for outputting one stereo sound to which the signal corresponds, the other speaker for outputting the other stereo sound, and a center speaker to be positioned between the one speaker and the other speaker,
the apparatus comprising:
an attenuating/delaying device which attenuates the input surround signal, and delays the surround signal per frequency band, and thereby generates an attenuated/delayed surround signal;
a center outputting device which outputs the generated attenuated/delayed surround signal to the center speaker;
a phase inverting device which inverts a phase of the input surround signal, and generates a reversed-phase surround signal; and
the other outputting device which outputs the generated reversed-phase surround signal to the other speaker.

8. The signal processing apparatus according to claim 7, further comprising:
a first filtering device which outputs a signal component having a predetermined frequency or less of the input surround signal to the attenuating/delaying device and the phase inverting device;
a second filtering device which outputs a signal component having a higher frequency than the predetermined frequency of the input surround signal; and
a second attenuating/delaying device which attenuates the signal component output from the second filtering device, and delays the signal component per frequency band, and thereby generates a second attenuated/delayed surround signal,
wherein the attenuating/delaying device generates the attenuated/delayed surround signal based on the signal component output from the first filtering device,
the phase inverting device generates the reversed-phase surround signal based on the signal component output from the first filtering device, and
the other outputting device outputs the reversed-phase surround signal and the second attenuated/delayed surround signal to the other speaker.

9. The signal processing apparatus according to claim 8,
wherein the other outputting device outputs the reversed-phase surround signal to a low-tone range speaker contained in the other speaker, and outputs the second attenuated/delayed surround signal to a high-tone range speaker contained in the other speaker.

10. The signal processing apparatus according to claim 7,
wherein the amount of delay per frequency band used for delaying a signal by the attenuating/delaying device is preset such that a difference in sound pressure level between both ears at a preset receiving/listening position is maximum when a sound is output from the one speaker, the other speaker, and the center speaker in response to an input of the surround signal.

11. The signal processing apparatus according to claim 7,
wherein the attenuating/delaying device and the phase inverting device are correspondingly provided at the right and left sides, respectively,
the one outputting device adds the surround signal corresponding to the one speaker, and the reversed-phase surround signal corresponding to the other speaker and generated by the phase inverting device, and outputs one addition signal to the one speaker,
the other outputting device adds the surround signal corresponding to the other speaker, and the reversed-phase surround signal corresponding to the one speaker and generated by the phase inverting device, and outputs the other addition signal to the other speaker, and
the center outputting device adds the attenuated/delayed surround signals generated by the attenuating/delaying device at the right and left sides, and outputs a center addition signal to the center speaker.

12. A signal processing method, comprising:
a process of outputting an input surround signal to one speaker among the one right or left speaker for outputting one stereo sound to which the signal corresponds, the other speaker for outputting the other stereo sound, and a center speaker to be positioned between the one speaker and the other speaker;
a process of attenuating the input surround signal, delaying the surround signal per frequency band, thereby generating an attenuated/delayed surround signal, and outputting the attenuated/delayed surround signal to the center speaker; and
a process of inverting a phase of the input surround signal, generating a reversed-phase surround signal, and outputting the reversed-phase surround signal to the other speaker.
